(19) United States
(12) Patent Application Publication
(10) Pub. No.: US 2026/0264802 A1
(43) Pub. Date: Sep. 10, 2026

(54) Drive unit for an electric bicycle with a bearing point for a stator and assembly method

(71) Applicant: Brose Antriebstechnik GmbH & Co. Kommanditgesellschaft, Berlin, Berlin (DE)

(72) Inventors: Michael JACOB, Meura (DE); Christoph EHEHALT-BOHM, Kurnach (DE); Daniel HUCKSTADT, Berlin (DE); Robert FRIEDLAND, Strausberg (DE); Stefanie PFRIEM, Gerbrunn (DE)

(21) Appl. No.: 19/164,889

(22) PCT Filed: Mar. 12, 2024
(86) PCT No.: PCT/EP2024/056456

§ 371 Date: Sep. 12, 2025

(30) Foreign Application Priority Data
Mar. 14, 2023 (DE) 10 2023 106 359.6

(51) Int. Cl. B62M 6/40; H02K 5/15; H02K 5/173; H02K 7/16; H02K 15/144; H02K 21/16

(52) U.S. Cl. CPC B62M 6/40; H02K 5/15; H02K 5/1732; H02K 7/16; H02K 15/144; H02K 21/16

(57) ABSTRACT

The invention relates, in particular, to a drive unit for an electric bicycle, comprising an electric motor drive having a stator and a rotor, wherein the rotor can be rotated about a rotor axis, and comprising a housing part in which a bearing point for the stator is provided. The bearing point comprises a wall running around the rotor axis, which borders a receiving means for the stator. An edge region is formed on the wall, which extends in a circumferential direction around the rotor axis, and which projects axially in relation to the rotor axis and is surrounded by an encompassing portion of a component mounted on the housing part, so that the edge region is supported by a part of the encompassing portion in a direction pointing radially outwards relative to the rotor axis.

### CROSS-REFERENCE TO RELATED APPLICATION

This application is a National Stage of International Application No. PCT/EP2024/056456 filed on Mar. 12, 2024, which claims priority from German Patent Application 10 2023 106 359.6, filed on Mar. 14, 2023. The contents of the above document are incorporated herein by reference in its entirety.

### BACKGROUND OF THE INVENTION

### Field of the Invention

The proposed solution relates in particular to a drive unit for an electric bicycle.

### Description of the Related Art

Drive units for electric bicycles with at least one electric motor drive are widely known. At least one electric motor drive is used here to provide an externally operated drive torque at an output element of the drive unit. The output element is then coupled, for example, to a force transmission element which is connected to a rear wheel of the electric bicycle via a transmission member such as a belt or a chain. The externally operated drive torque is typically provided in addition to a muscle operated drive torque which is applied to a pedal shaft via pedals.

In the meantime, the output element and the force transmission element are regularly provided on a pedal shaft assembly comprising the pedal shaft with a freewheel. This supports a compact configuration of the drive unit, since the rotation axis of the pedal shaft is identical to the rotation axes of the output element and the force transmission element.

At least one electric motor with a stator and a rotor is typically provided for the electric motor drive of the drive unit. The stator is housed in a housing part of the drive unit and supported to be rotatably fixed. The housing part forms a bearing location for this purpose, for example in the form of a bearing housing, at which the stator—if necessary, together with the rotor already pre-assembled thereon—is arranged during assembly of the drive unit. The positionally precise arrangement and fixing of the stator at the housing side bearing location is particularly important with regard to the occurrence of any disruptive torques during operation of the electric motor drive. If the stator is not positioned centrally with respect to a rotor axis of the rotating rotor, if the stator is excessively deformed, or if the centered position of the stator cannot be reliably ensured during operation of the drive unit, disruptive torques result due to axial deviation and/or ovalization of the stator.

### SUMMARY OF THE INVENTION

Against this background, there is a need for an improved drive unit in this respect and an improved assembly method in this respect, whereby the stator can be fixed more easily and/or more stably positionally precise on the housing part and/or the assembly of the drive unit can be simplified.

According to one aspect of the proposed solution, a drive unit for an electric bicycle is provided, which has an electric motor drive comprising a stator and a rotor, as well as a housing part in which a bearing location for the stator is provided, which comprises a wall revolving around a rotor axis of the rotor. This wall borders a receptacle for the stator at the bearing location. A (interrupted or continuous) edge region extending in a circumferential direction around the rotor axis is also formed at the wall, which protrudes axially relative to the rotor axis and is encompassed by an encompassing portion of a component assembled to the housing part, so that the edge region is supported by a part of the encompassing portion in a direction facing radially outward relative to the rotor axis.

The axially protruding (opposite to an assembly direction along which the stator is attachable to the receptacle) encompassing portion on the wall is therefore encompassed by the encompassing portion of the component additionally assembled to the housing part in order to provide a radially outer support for the edge region. The bearing location is thus specifically reinforced at the edge region via the component additionally assembled to the housing part. Thus, an increased structural rigidity due to the component assembled to the housing part is achieved at an insertion opening of the bearing location which is enclosed by the edge region and intended for arranging the stator in the receptacle. This is particularly effective in counteracting any ovalization of the stator during and after assembly on the bearing location due to forces applied from outside or occurring during operation of the drive unit.

With a circumferentially revolving encompassing portion, i.e., completely running along a circumferential line about the rotor axis, and the associated encompassing of the edge region, the component that is additionally assembled to the bearing location and has the encompassing portion can also be easily centered with respect to the rotor axis. The connection between the encompassing portion and the edge region simply results in automatic centering of the component when it is attached to the housing part.

In one embodiment, the edge region is formed with an edge protruding axially on the wall, which extends annularly around the rotor axis. The edge region thus has, for example, an annular axially protruding collar or flange which is encompassed on the outside by the encompassing portion in a state of the drive unit being assembled as intended.

The encompassing portion is formed, for example, on a bottom side facing the stator of the component assembled to the bearing location, protruding axially in the direction of the wall. The bottom side of the component assembled to the bearing location may partially or completely cover an axial end face of the stator and may thus also partially or completely cover an insertion opening of the bearing location for the stator, which is encompassed by the edge region.

For a complete circumferential encompassing of the edge region, the encompassing portion at the component assembled to the bearing location can, for example, extend annularly around the rotor axis.

For example, the encompassing portion and the edge region are connected to each other with a transition fit or an oversize fit. The component assembled to the bearing location is therefore regularly connected to the edge region in a force-fitting manner during assembly to the housing part.

The component assembled to the bearing location is, for example, part of a transmission assembly of the drive unit, whose transmission elements are coupled to the rotor of the electric motor drive. For example, the rotor may have a motor shaft with a pinion formed thereon or connected thereto in a rotationally fixed manner, which meshes with a gear wheel of the transmission assembly in order to transmit a drive torque generated by the electric motor drive in the direction of a force transmission element of the drive unit. A rear wheel of the electric bicycle is to be coupled to a corresponding force transmission element, for example, via a transmission member such as a belt or a chain in order to drive it. The component having the encompassing portion is now part of a corresponding transmission assembly provided for torque transmission, so that assembling at least one part of the gear of the drive unit to the housing part also entails stiffening the bearing location for the stator already arranged therein.

At least one transmission element of the transmission assembly can be rotatably supported on the component of the transmission assembly assembled to the bearing location. This also includes the component assembled to the bearing location being a transmission carrier of the transmission assembly on which several (at least two) transmission elements of the transmission assembly that interact with each other are rotatably supported. Corresponding transmission elements of the transmission assembly that interact with each other can, for example, be gear wheels meshing with each other.

For further functional integration into the component having the encompassing portion (alternatively or in addition to a function as a transmission carrier), this component can have a bearing portion on which at least one electronic component of the drive unit is arranged. The component can thus be configured and provided for supporting and, in particular, fixing of at least one electronic component of the drive unit and, thus, also in such an embodiment, does not serve exclusively to stiffen the bearing location at the edge region. For example, the component can be configured and provided for the arrangement of at least one electronic component of a control electronic of the drive unit, and in particular at least one printed circuit board. For example, a printed circuit board is fixed to the bearing portion when the drive unit is assembled as intended.

In principle, it may be provided that the stator is pressed into the bearing location. This includes the stator being pressed into the bearing location with thermal support, i.e., for example, by heating the housing part before and/or during insertion of the stator into the bearing location.

Another aspect of the proposed solution, which can be easily combined with the first aspect explained above, relates to a drive unit in which at least one first recess is formed on the wall of the receptacle and at least one second recess is provided on an outer skin surface of the stator, located opposite the first recess. A form-fit element for fixing the stator to the bearing location engages in the first recess and the second recess, the form-fit element comprising a transmission portion for transmitting an axially acting biasing force with respect to the rotor axis to the stator.

According to this aspect of the proposed solution, a form-fit element, which can be formed by a separate component and is then assembled after insertion of the stator into the receptacle of the bearing location, is provided not only for fixing the stator at the bearing location via a form-fit connection, but also for transmitting an axially acting biasing force to the stator. By the form-fit element, thus, not only a (possibly additional) form-fit connection between the stator and the bearing location—for example, in the form of a tongue and groove connection—can be provided. Rather, the form-fit element serves to transmit an axial biasing force to the stator. The stator is thus secured against rotation about the rotor axis at the bearing location by means of at least one form-fit element (if necessary additionally, for example in addition to a force-fit connection between an outer skin surface of the stator and the wall). In addition, a biasing force acting in the axial direction and thus parallel to the rotor axis is transmitted to the stator via the transmission portion of the form-fit element in order to secure the axial posture of the stator at the bearing location.

For example, the form-fit element can be received with a form-fit portion in the first recess of the wall and the second recess of the stator. The superimposed portion can in turn be formed to be shiftable, in particular elastically shiftable, relative to this form-fit portion. For example, before the form-fit element is attached to the bearing location with the stator already in place, the transmission portion is in a first relative posture with respect to the form-fit portion. If the form-fit element is assembled to the wall and the stator as intended, the transmission portion can be shifted from this first relative position into a second other relative position with respect to the form-fit portion under the effect of the applied axially acting biasing force. For example, the transmission portion can be shifted by attaching a further component to the housing part. In such an embodiment, the component assembled to the housing part consequently loads the transmission portion during assembly in such a way that the transmission portion is shifted by the biasing force applied by means of the attached additional component, relative to the form-fit portion received in the first and second recesses by form fit.

For example, the transfer portion can be formed to protrude radially inward on the form-fit element, relative to the rotor axis and a form-fit portion, when the form-fit element has been mounted on the first and second recesses as intended. For example, this entails an L-shaped cross section of the form-fit element in a cross-sectional view, wherein a first leg of the L-shape is defined by the form-fit portion and a second leg of the L-shape is defined by the transmission portion.

The form-fit portion can generally be formed to be elongated and, in particular, pin-shaped or rod-shaped. The first and second recesses can each be elongated and longitudinally grooved, in particular with a longitudinal axis running substantially or exactly parallel to the rotor axis.

In one embodiment, the form-fit element additionally comprises a head portion via which the form-fit element can be subjected to an assembly force during assembly of the drive unit for insertion into the first and second recesses, under the effect of which a form-fit portion of the form-fit element is displaced along the first and second recesses into an end posture. The head portion provided on the form-fit element is configured and intended to be subjected to an assembly force, by which the form-fit portion is displaced along the first and second recesses into a final posture provided for this purpose, in particular is pressed. The head portion can be provided, in particular can be formed, on the form-fit element at a spatial distance from the transmission portion. In this way, the assembly force and, following assembly, the axial biasing force can act on the form-fit element at different locations provided for this purpose. Consequently, different portions are provided on the form-fit element at which the assembly force can be applied to the form-fit element on the one hand and the axial biasing force on the other.

In principle, several first and second recesses may be provided on the wall of the bearing location and also on the outer skin surface of the stator, into each of which a form-fit element engages. Form-fit elements may thus be provided at various locations of the circumference of the stator or the bearing location for fixing the stator in the bearing location, each with a transmission portion for transmitting an axial biasing force to the stator.

The axial biasing force on the transmission portion of the form-fit element is applied, for example, by a component of the drive unit assembled to the bearing location. This component may be, for example, part of a transmission assembly of the drive unit and, in particular, a transmission carrier mentioned above. A component for applying the axial biasing force to the transmission portion may also be a component which forms an encompassing portion for stiffening an edge region of the bearing portion, with reference to the first aspect of the proposed solution explained above.

Part of the proposed solution is an electric bicycle with an embodiment of the proposed drive unit.

Furthermore, a method for assembly of a stator to a housing part of a drive unit for an electric bicycle is part of the proposed solution.

This includes, in particular, an assembly method in which
an (interrupted or continuous) edge region extending in a circumferential direction about a rotor axis is formed on a wall of a bearing location, which protrudes axially relative to the rotor axis, and
after a stator and a rotor of the drive unit have been arranged at the bearing location, a component of the drive unit is assembled to the housing part, which encompasses the edge region of the bearing location with an encompassing portion, so that the edge region is supported in a direction pointing radially outward relative to the rotor axis by a part of the encompassing portion.

For example, the component assembled to the bearing location is centered relative to the rotor axis via the connection of its encompassing portion to the edge region of the bearing location. The provision of additional stiffening at the edge region of the bearing location via the component additionally assembled thereto and having an encompassing portion thus results in automatic centering of the component relative to the rotor axis during assembly of the component to the housing part due to the bearing location.

The component assembled to the bearing location can, for example, be part of a transmission assembly of the drive unit, whose transmission elements are coupled to the rotor of the electric motor drive. As already explained above, this can therefore be a transmission carrier of the transmission assembly, on which at least one transmission element of the transmission assembly is rotatably supported. In particular, the at least one transmission element may already be rotatably assembled to the transmission carrier and the transmission assembly may therefore be pre-assembled before the transmission carrier is assembled to the bearing location with an encompassing portion.

In an alternative or in addition to the provided assembly method, at least one first recess is formed on a wall of the bearing location, to which a second recess on an outer skin surface of a stator of the drive unit is opposite when the stator has been inserted into a receptacle of the bearing location as intended. In one of the subsequent assembly steps, a form-fit element is inserted into the first recess and the second recess opposite thereto for fixing the stator to the bearing location. This form-fit element has a transmission portion for transmitting an axially acting biasing force to the stator relative to a rotor axis of a rotor of the drive unit.

The form-fit element can, for example, be inserted into the first and second recesses until the form-fit element abuts against a portion of the stator with a shoulder of the transmission portion. The form-fit element is inserted, for example, into the first and second recesses along an assembly direction (along which the stator is also inserted into the housing) until the form-lock element is in an end posture in which the transmission portion—e.g., in the region of the outer circumference of the stator—abuts against an edge portion of the stator and can transmit the axial biasing force to the stator via this.

If the form-fit element is inserted into the first recess of the wall and the second recess of the stator with a form-fit portion as intended, the transmission portion is biased with the axial biasing force in order to secure the stator axially (additionally, if necessary) in the receptacle. In this case, the transmission portion for transmitting the axial biasing force to the stator can be shifted, in particular elastically shifted, relative to the form-fit portion engaging in the first and second recesses by a component of the drive unit assembled subsequently to the housing part.

As already mentioned above, the component which, when assembled to the housing part, shifts the transmission portion and applies the axial biasing force to the transmission portion may be precisely the component which forms an encompassing portion for a stiffening encompassing of an edge region of the bearing location. In particular, the component applying the axial biasing force can be formed by a part of a transmission assembly of the drive unit, in particular a transmission carrier of the transmission assembly.

In the course of a proposed assembly method, it may generally be provided that the stator is pressed into the receptacle of the bearing location, in particular by heating at least a part of the housing part.

Embodiments of a proposed assembly method are particularly suitable for assembly of a stator to a housing part in an embodiment of a proposed drive unit. The advantages and features of embodiments of a proposed drive unit (according to the first and/or second aspect) explained above and below therefore also apply to embodiments of a proposed assembly method and vice versa.

### BRIEF DESCRIPTION OF THE DRAWINGS

The accompanying figures illustrate examples of possible embodiments of the proposed solution.

FIGS. 1A-1B show an embodiment of a proposed drive unit in perspective view with a view onto different longitudinal sides;

FIG. 2A shows a first housing part of the housing of the drive unit of FIGS. 1A and 1B with a view onto its outer side;

FIG. 2B shows the first housing part of FIG. 2A with a view onto its inner side;

FIG. 3 shows the first housing part with a stator of an electric motor drive of the drive unit assembled thereto;

FIG. 4 shows the first housing part in a subsequent assembly step, in which a rotor is assembled to the first housing part already having the stator;

FIG. 5 shows the first housing part with the stator assembled thereto and the rotor assembled thereto;

FIG. 6 shows the first housing part in a subsequent assembly step, in which a gear assembly and a bearing shield are assembled to the first housing part already having the stator and the rotor;

FIG. 7 shows the first housing part with the gear assembly fixed thereto and the bearing shield fixed to the gear assembly;

FIG. 8 shows a single view of a transmission carrier of the gear assembly, with a view onto its bottom side;

FIG. 9 shows a sectional view of the first housing part with the rotor attached thereto and the stator attached thereto, as well as the gear assembly already fixed to the first housing part and the bearing shield attached thereto;

FIG. 10 shows an enlarged portion of FIG. 9, in particular to illustrate a stiffening encompassing of an axially protruding edge region of the bearing location by an encompassing portion of the transmission carrier;

FIG. 11 shows an embodiment of a portion, in which a form-fit element is inserted into recesses of a wall of the bearing location and an outer skin surface of the stator in a form-fit manner, via which an axial biasing force applied by the transmission carrier can be transmitted to the stator.

### DETAILED DESCRIPTION OF THE DRAWINGS

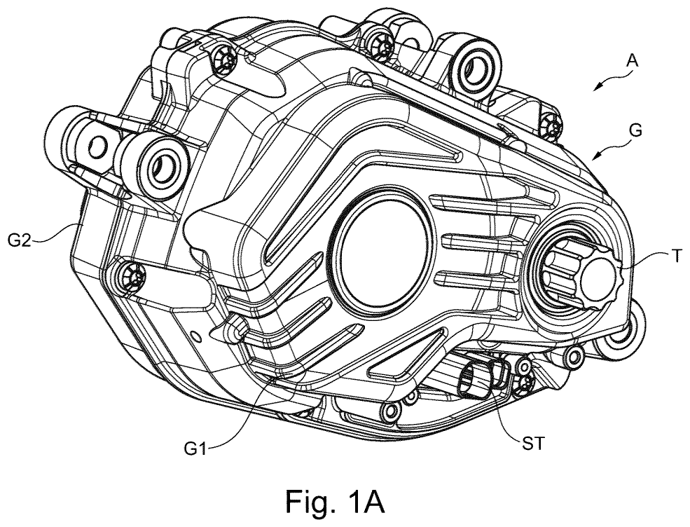

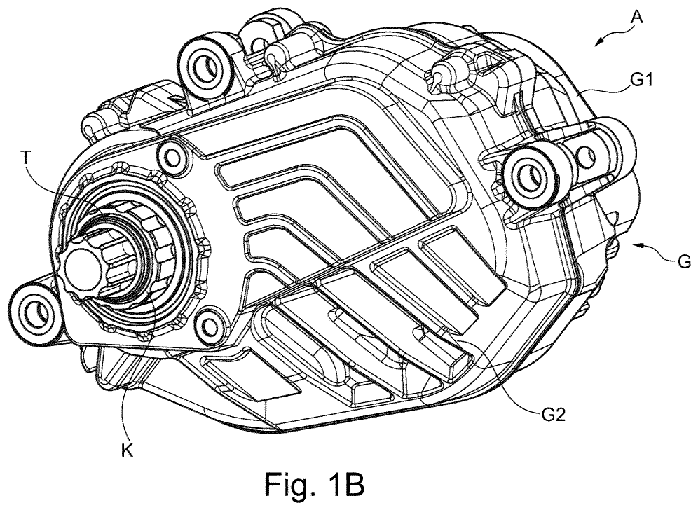

The FIGS. 1A and 1B show a drive unit A for an electric bicycle in different perspective views looking at two different side surfaces. The drive unit A comprises a housing G which houses electronic and mechanical components. This housing G comprises two interconnected first and second housing parts G1 and G2, each of which defines a housing half.

An end of a pedal shaft T protrudes from both sides of the housing G. Pedals can be attached to these ends so that, after the drive unit A has been assembled to an electric bicycle as intended, a drive torque can be applied to the pedal shaft T by muscle force to drive the electric bicycle. In particular, a torque generated by muscle power is transmittable to a rear wheel of an electric bicycle via a force transmission element K on the pedal shaft T, e.g. by means of a belt wheel or chainring connected in a rotationally fixed manner to the power transmission element K, and via a transmission member, such as a belt or a chain. An externally operated generated torque, which is provided by an electric motor drive housed in the housing G and transmitted to the power transmission element K via a transmission also housed in the housing G, can be applied to the power transmission element K.

On one side formed by the first housing part G1, a plug connector portion ST leading out of the interior of the housing G is visible. This plug connector portion ST has one or more plug connectors for connecting the drive unit A to a current supply and/or a higher-level control electronics on the electric bicycle.

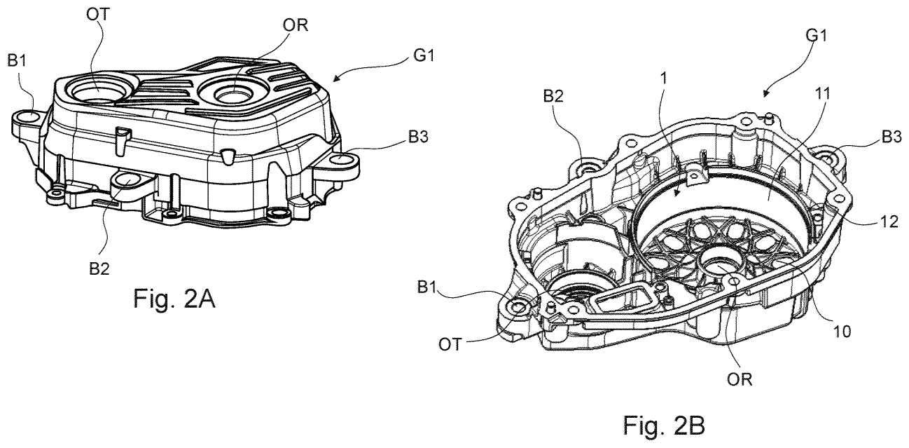

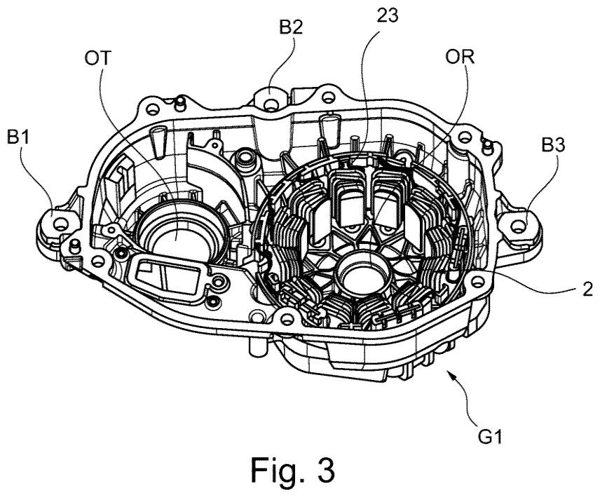

The FIGS. 2A and 2B show the first housing part G1 for an embodiment of a proposed drive unit A in individual illustration in different views. The first housing part G1 is here formed as a housing half which, together with the second housing part G2, defines a housing space in which electronic and mechanical components of the drive unit A are to be housed. For connection to the second housing part G2 and thus, in the present case, to a second housing half, the first housing part G1 has several (at least two)—in the present case three—fastening locations B1, B2, and B3 distributed on an outer circumference of the first housing part G1. In addition, a housing opening OT for the pedal shaft T of the drive unit A and a bearing opening OR for a rotor shaft 30 of an electric motor drive of the drive unit A are formed on the first housing part G1. The rotor shaft 30 is part of a rotor 3 which is rotatable relative to a stator 2 of the electric motor drive about a rotor axis R coinciding with the shaft axis of the rotor shaft 30 in order to provide an externally operated generated drive torque (see in particular FIGS. 3 to 7).

As can be seen in particular with view onto the inside of the first housing part G1 according to FIG. 2B, the first housing part G1 forms a (motor) bearing location 1 with a bearing housing. The bearing location 1 is in particular intended for the arrangement of the stator 2 of the electric motor drive.

The pot-shaped bearing location 1 or the bearing location formed with the bearing housing within the first housing part G1 has a wall 11 that runs completely circumferentially along a circular line around the bearing opening OR for the rotor shaft 30 (and thus around a rotor axis R of the rotor 3 defined by the rotor shaft 30). This wall 11 runs perpendicular to a bottom 10 of the bearing location 1, which in the present embodiment is exemplarily formed with ribs extending in a bloom shape with respect to the bearing opening OR.

In the FIG. 3, the stator 2 is already inserted into the first housing part G1 upon assembly of the drive unit A and fixed in place before the rotor 3 is assembled to the housing part G1 along the assembly direction parallel to the rotor axis R and inserted into the stator 2 for this purpose. A base body 20 of the stator 2 carries the coils 23 of the stator 2 and is arranged completely in the pot-shaped receptacle of the bearing location 1.

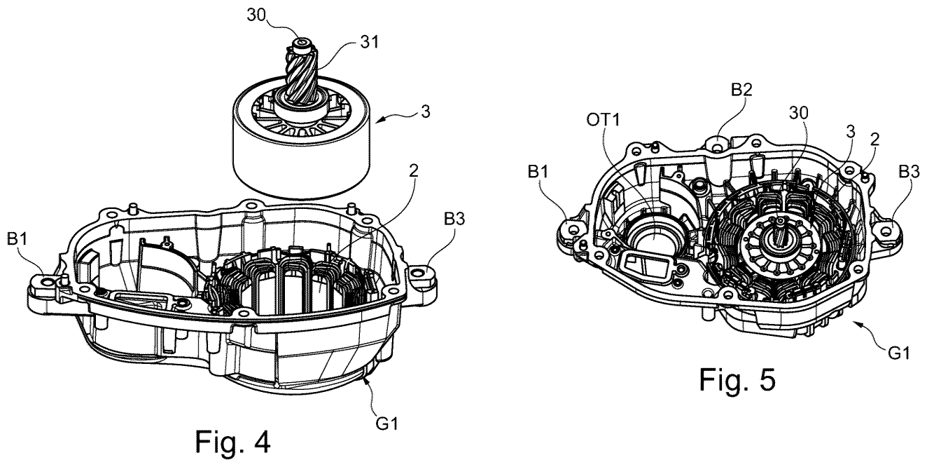

After the assembly of the stator 2 to the first housing part G, the multi-part rotor 3 is inserted into the stator 2 and thus into the first housing part G1 in a subsequent assembly step, as illustrated in the FIG. 4. The rotor 3 comprises a rotor unit with sheet-encased magnets and a rotor shaft 30. A (motor) pinion 31 is formed or fixed in a rotationally fixed manner on the rotor shaft 30 so that a drive torque generated by the electric motor drive 2, 3 can be transmitted via the pinion 31.

In a state of the drive unit A being assembled as intended, an externally operated generated drive torque is transmitted from the pinion 31 to a transmission which is coupled to the power transmission element K. In the present case, at least part of this transmission is provided by a pre-assembled transmission assembly 4. This transmission assembly 4 is assembled to the first housing part G1 after the stator 2 and the rotor 3 have already been arranged in the bearing location 1 as intended, as it is shown in FIG. 5.

In the present case, several gear wheels meshing with one another are rotatably mounted on a transmission carrier 40 of the transmission assembly 4, in particular a gear wheel intended for meshing with the pinion 31 when the transmission assembly 4 is assembled to the first housing part G1 as intended. The corresponding gear wheels of the transmission can be pre-assembled to the transmission carrier 40.

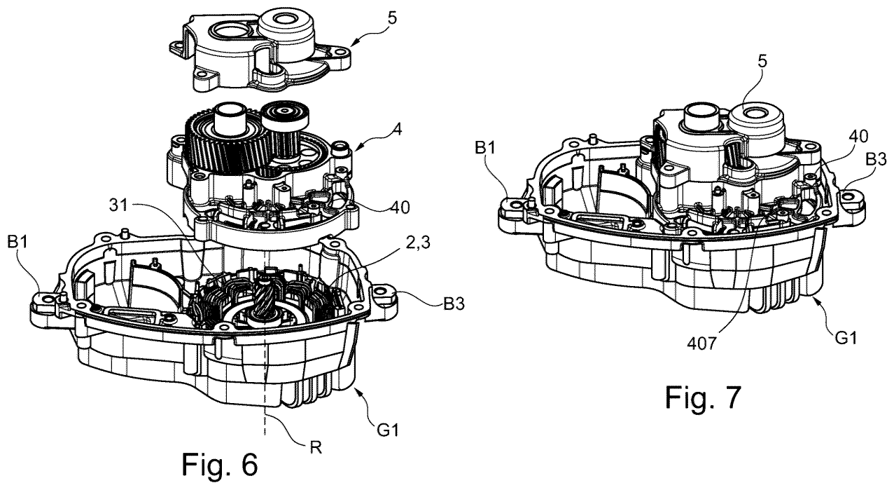

Once the transmission assembly 4 is completely pre-assembled, it is assembled to the first housing part G1 in accordance with the assembly step shown in FIG. 6 and fixed inside the first housing part G1 by means of fastening elements, for example in the form of screws or bolts. A bearing shield 5 is then arranged and fixed to the transmission assembly 4 inserted in this way into the first housing part G1 (see FIG. 7).

After assembling further mechanical and electronic components to the first housing part G1, the second housing part G2 is attached to the first housing part G1 and fixed in place. Thereby, the housing space of the housing G housing the transmission assembly 4 and the motor drive 2, 3 is closed in a sealed manner.

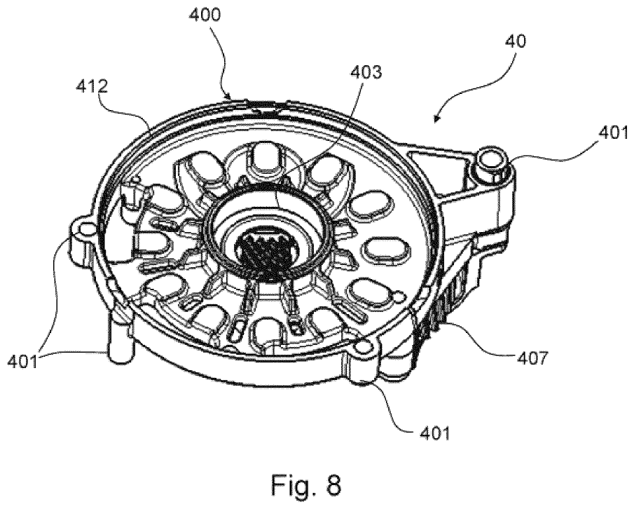

Based on FIGS. 8, 9, and 10, in particular the connection of the transmission carrier 40 to the first housing part G1 at the bearing location 1 is illustrated.

The FIG. 8 shows the transmission carrier 40 in a perspective individual view with a view to its bottom side 400, which faces the stator 2 housed in the receptacle of the bearing location 1, in a state of being assembled to the first housing part G1. The transmission carrier 40 has several fastening locations 401 on its outer circumference, at which fixing of the transmission carrier 40 to the first housing part G1 is performed, for example by means of screws or bolts.

The transmission carrier 40 has an encompassing portion 412 circumferentially revolving and protruding in the axial direction on its bottom side 400. This encompassing portion 412 is here ring-shaped and formed as a stiffening and centering ring 412, by which not only the transmission carrier 40 is centered relative to the rotor axis R when it is attached to the first housing part G1. Rather, by means of the stiffening and centering ring 412, stiffening of the bearing location 1 at the insertion opening open toward the gear assembly 4, through which the stator 2 and the rotor 3 are inserted into the bearing location 1, is also achieved. If the transmission carrier 40 is assembled to the first housing part G1 as intended according to the FIGS. 6 and 7, so that the transmission carrier 40 covers the insertion opening and thus also an end side of the stator 2, the transmission carrier 40 with the stiffening and centering ring 412 encompasses an annular edge region 12 of the bearing location 1 which protrudes axially in the opposite direction to the mounting direction (and thus upward during assembly) of the bearing location 1.

By the stiffening and centering ring 412 of the transmission carrier 40 being plugged on the edge region 12 of the bearing location 1, which completely revolves at the wall 11 and is thus continuous and annularly projecting, so that at least one (supporting) part of the stiffening and centering ring 412 supports the edge region 12 in a direction pointing radially outward relative to the rotor axis R, the bearing location 1 is stiffened at its upwardly open end and thus in the region of the insertion opening via the transmission carrier 40 assembled to the first housing part G1. At the same time, the transmission carrier 40 is reliably centered relative to the stator 2 and relative to the rotor 3 by means of its stiffening and centering ring 412 inserted into the edge region 12, so that a pinion opening 403 formed on the transmission carrier 40 can be plugged over the end of the rotor shaft 30 protruding from the rotor 3, on which the pinion 31 is provided. In this way, the transmission carrier 40 is aligned with the stator 2 and the rotor 3 in such a way that, when the transmission assembly 4 is assembled to the first housing part G1, a gear wheel of the transmission assembly 4, which is already rotatably supported on the transmission carrier 40 as intended, is brought into meshing engagement with the pinion 31.

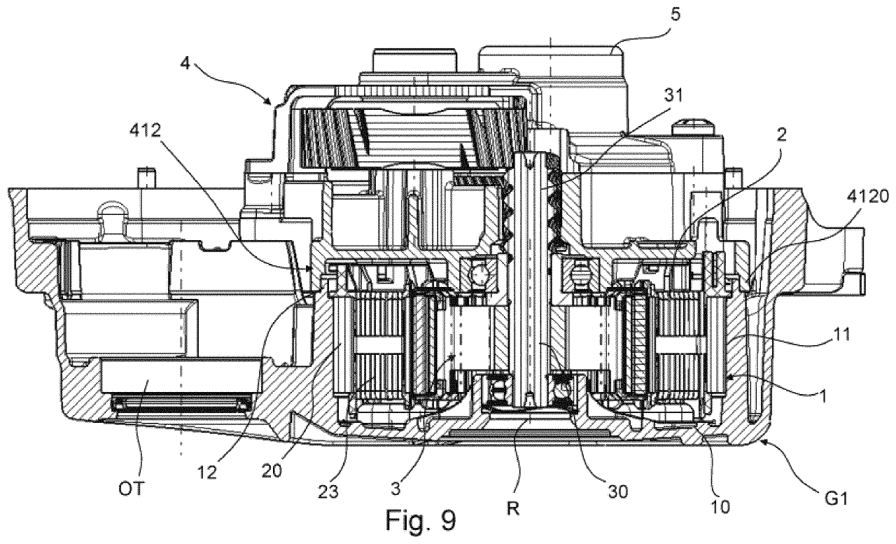

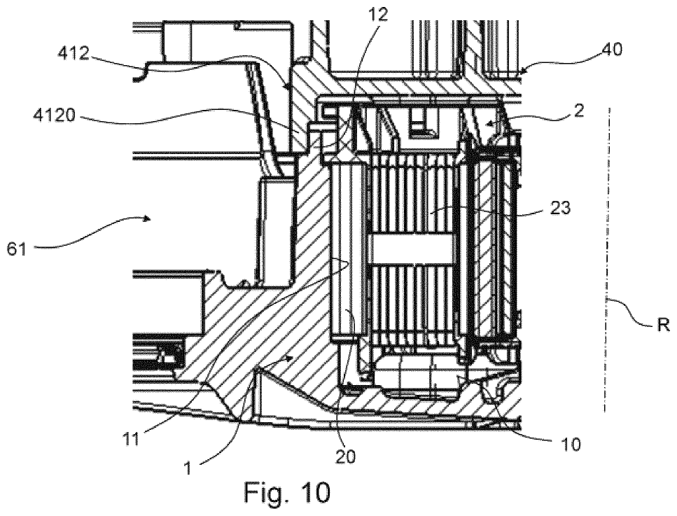

As also illustrated by the sectional illustration of FIG. 9 and the enlarged excerpt of FIG. 10, after assembly of the transmission assembly 4 to the first housing part G1, the transmission carrier 40 and the bearing location 1 at the stiffening and centering ring 412 and the edge region 12 are connected to each other in a force-fitting manner via a transition fit or an oversize fit. Thereby, a fixed connection between the transmission carrier 40 and the wall 11 of the bearing location 1, which is stiffened at its upper end open toward the transmission assembly 4 by the stiffening and centering ring 412. The resulting increased structural rigidity counteracts ovalization of the stator 2 in particular. The transmission carrier 40 of the transmission assembly 4 thus serves not only for the pre-assembly of the transmission elements (here in the form of meshing gear wheels) to be supported rotatably thereon, but also for the additional stiffening of the bearing location 1.

In addition, in the embodiment shown, the transmission carrier 40 also forms a bearing portion 407 for at least one electronic component of the drive unit A. At least one component of a control electronics of the drive unit A is arranged and fixed on the bearing portion 407 on a bearing surface facing away from the stator 2, for example at least one printed circuit board which is connected to the plug connector portion ST (directly or via at least one additional electronic component, such as a further printed circuit board and/or one or more lines).

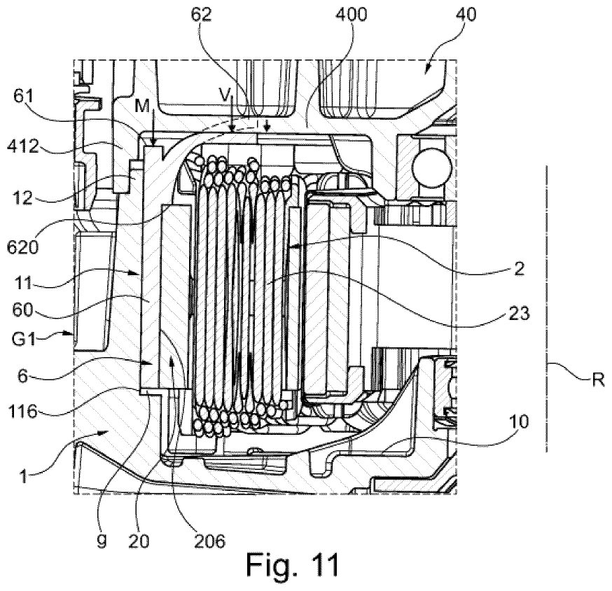

Based on the enlarged sectional illustration of FIG. 11, an embodiment of the proposed solution, in which the stator 2 is secured radially and axially in the pot-shaped receptacle of the bearing location 1 by means of at least one additional form-fit element 2. This form-fit element 6 is inserted with an elongated, pin- or rod-shaped form-fit portion 60 into a first recess 116 of the wall portion 11 and a second recess 216 of the stator 2. The first recess is formed as a longitudinal groove 116 on an inner side of the wall 11, and the second recess, which is opposite the first recess 116, is formed as a longitudinal groove 206 on an outer skin surface of a base body 20 of the stator 2. The form-fit portion 60, which extends parallel to the rotor axis R in the present case, is thus inserted in a form-fit manner into the two longitudinal grooves 116 and 206 along an assembly direction parallel to the rotor axis R after the stator 2 has been inserted into the bearing location 1. The stator 2 is (additionally) secured against rotation relative to the wall 11 around the rotor axis R by the form-fit portion 60 of the form-fit element 6 engaging in both longitudinal grooves 116 and 206.

In order to insert the elongated form-fit portion 60 into the both longitudinal grooves 116 and 206, the form-fit element 6 forms a head portion 61 at its one end. An assembly force M can be exerted via this head portion 61 in the direction of the bottom 10 of the bearing location 1 and thus in the axial direction in order to press the form-fit portion 60 downwards into an end posture along the longitudinal grooves 116 and 206. The axial length of the longitudinal groove 116 on the wall portion side is greater than the length of the form-fit portion 60, so that the form-fit element 6 abuts against a radially inwardly protruding shoulder 620 of a transmission portion 62 on an end side of the stator 2. In the state of being maximally inserted into the longitudinal grooves 116 and 206 as intended, a gap g remains between an axial end of the form-fit portion 60 facing away from the head portion 61 and an end of the longitudinal groove 116 on the wall portion side lying in the assembly direction. If the form-fit element 6 is therefore maximally inserted as intended into the longitudinal grooves 116 and 206, the transmission portion 62 with the shoulder 620 abuts against an edge of the stator 2.

A transmission portion 62 protrudes from the head portion 61 at the form-fit element 6 in a radially inward facing direction with a region which can be loaded in the axial direction via the bottom side 400 of the transmission carrier 40. The form-fit element 6, which is L-shaped in cross-section here, is loaded with a biasing force V acting axially in the direction of the stator 2 at its transmission portion 62 when the transmission carrier 40 is attached to the first housing part G1. Under the effect of this biasing force V, the transmission portion 62, which is elastically shiftable relative to the form-fit portion 60, is shifted toward the end side of the stator 2. The transmission portion 62 is therefore axially loaded by the transmission carrier 40 attached to and fixed to the first housing part G1, so that the biasing force V acts on the transmission portion 62. This biasing force V can be transmitted to the stator 2 via the transmission portion 62 and its shoulder 620. The stator 2 is thus additionally secured axially.

Deviating from the variant illustrated in FIG. 11, it is of course not essential that the transmission carrier 2 applying the axial biasing force V also forms the stiffening and centering ring 412, which is provided for stiffening the bearing location 1 at the edge region 12, which axially protrudes and annularly revolves according to kind of a bottom or collar. The additional functional integration into the transmission carrier 40 can simplify the assembly processes for the drive unit A to a considerable extent.

### LIST OF REFERENCE SIGNS

1 Bearing location
10 Bottom
11 Side wall
116 Longitudinal groove
12 Edge region
2 Stator
20 Base body
206 Longitudinal groove
23 Coil
3 Rotor
30 Rotor shaft
31 (Motor) pinion
4 Transmission assembly
40 Transmission carrier
400 Bottom side
401 Fastening location
403 Pinion opening
407 Bearing portion
412 Reinforcing and centering ring (encompassing portion)
4120 Support part
5 Bearing shield
6 Form-fit element
60 Form-fit portion
61 Head portion
62 Transmission portion
620 Heel
A Drive unit
B1-B3 Connection location
G Housing
G1, G2 Housing half (housing part)
g Gap
K Force transmission element
M Assembly force
OR Bearing opening for rotor shaft
OT Housing opening for pedal shaft
R Rotor axis
ST Plug connector portion
T Pedal shaft (assembly)
V Biasing force

What is claimed is:

1. A drive unit for an electric bicycle, comprising:
an electric motor drive comprising a stator and a rotor, the rotor being rotatable around a rotor axis, and
a housing part in which a bearing location for the stator is provided,
wherein the bearing location comprises a wall revolving around a rotor axis, which borders a receptacle for the stator,
and wherein
an edge region extending in a circumferential direction around the rotor axis is formed at the wall, which protrudes axially relative to the rotor axis and is encompassed by an encompassing portion of a component assembled to the housing part, so that the edge region is supported by a part of the encompassing portion in a direction facing radially outward relative to the rotor axis.

2. The drive unit according to claim 1, wherein the edge region is formed with an edge protruding axially on the wall, which extends annularly around the rotor axis.

3. The drive unit according to claim 1, wherein the encompassing portion protrudes axially in the direction of the wall on a bottom side facing the stator of the component assembled to the bearing location.

4. The drive unit according to claim 3, wherein the encompassing portion at the component assembled to the bearing location extends annularly around the rotor axis.

5. The drive unit according to claim 1, wherein the encompassing portion and the edge region are connected to each other with a transition fit or an oversize fit.

6. The drive unit according to claim 1, wherein the component assembled to the bearing location is centered relative to the rotor axis via its encompassing portion connected to the edge region.

7. The drive unit according to claim 1, wherein the component assembled to the bearing location is part of a transmission assembly of the drive unit, whose transmission elements are coupled to the rotor of the electric motor drive.

8. The drive unit according to claim 7, wherein at least one transmission element of the transmission assembly is rotatably supported on the component of the transmission assembly assembled to the bearing location.

9. The drive unit according to claim 7, wherein the component assembled to the bearing location is a transmission carrier of the transmission assembly on which several transmission elements of the transmission assembly, that interact with each other, are rotatably supported.

10. The drive unit according to claim 1, wherein the component assembled to the bearing location has a bearing portion on which at least one electronic component of the drive unit is arranged.

11. The drive unit according to claim 1 wherein the stator is pressed into the bearing location.

12. The drive unit according to claim 1, for an electric bicycle, comprising:
an electric motor drive comprising a stator and a rotor, the rotor being rotatable around a rotor axis, and
a housing part in which a bearing location for the stator is provided,
wherein the bearing location comprises a wall revolving around a rotor axis, which borders a receptacle for the stator,
wherein
at least one first recess is formed on the wall of the receptacle and at least one second recess is provided on an outer skin surface of the stator, located opposite the first recess, and
a form-fit element for fixing the stator to the bearing location engages in the first recess and the second recess, the form-fit element comprising a transmission portion for transmitting an axially acting biasing force with respect to the rotor axis to the stator.

13. The drive unit according to claim 12, wherein the form-fit element is received with a form-fit portion in the first recess of the wall and the second recess of the stator and the transmission portion is formed to be shiftable, in particular elastically shiftable, relative to this form-fit portion.

14. The drive unit according to claim 13, wherein the transfer portion is formed to protrude radially inward on the form-fit element, relative to the rotor axis and the form-fit portion.

15. The drive unit according to claim 14, wherein the form-fit element is formed L-shaped in a cross-sectional view with its form-fit portion and its transmission portion.

16. The drive unit according to claim 12, wherein the form-fit element additionally comprises a head portion via which the form-fit element can be subjected to an assembly force for insertion into the first and second recesses during an assembly of the drive unit, under the effect of which a form-fit portion of the form-fit element is displaced along the first and second recesses into an end posture.

17. The drive unit according to claim 16, wherein the head portion is provided on the form-fit element at a spatial distance from the transmission portion.

18. The drive unit according to claim 12, wherein several first recesses are provided on the wall of the bearing location and several second recesses respectively opposite to the first recesses on the outer skin surface of the stator as well as several form-fit elements, which respectively engage a pair of first and second recesses.

19-21. (canceled)

22. An electric bicycle with a drive unit comprising:
an electric motor drive comprising a stator and a rotor, the rotor being rotatable around a rotor axis, and
a housing part in which a bearing location for the stator is provided,
wherein the bearing location comprises a wall revolving around a rotor axis, which borders a receptacle for the stator,
and wherein
an edge region extending in a circumferential direction around the rotor axis is formed at the wall, which protrudes axially relative to the rotor axis and is encompassed by an encompassing portion of a component assembled to the housing part, so that the edge region is supported by a part of the encompassing portion in a direction facing radially outward relative to the rotor axis.

23. A method for assembly of a stator to a housing part of a drive unit for an electric bicycle, where a bearing location for the stator and a rotor rotatable around a rotor axis relative to the stator is provided at the housing part and the bearing location comprises a wall revolving around the rotor axis which borders a receptacle for the stator, the method comprising:
forming an edge region extending in a circumferential direction about a rotor axis on the wall, which protrudes axially relative to the rotor axis, and
assembling a component of the drive unit to the housing part, which encompasses the edge region of the bearing location with an encompassing portion, so that the edge region is supported in a direction pointing radially outward relative to the rotor axis by a part of the encompassing portion, after the stator and the rotor have been arranged at the bearing location.

24-33. (canceled)
